(19) United States
(12) Patent Application Publication
(10) Pub. No.: US 2011/0225829 A1
(43) Pub. Date: Sep. 22, 2011

(54) HEAVY DUTY CONFIGURABLE SHEAR CRUSHER DEMOLITION TOOL

(75) Inventor: Daniel J. Raihala, Superior, WI (US)

(73) Assignee: Genesis Attachments, LLC, Superior, WI (US)

(21) Appl. No.: 12/728,633

(22) Filed: Mar. 22, 2010

(51) Int. Cl. B23D 17/00; B02C 1/10; B23D 35/00

(52) U.S. Cl. 30/134; 241/264; 241/291

(57) ABSTRACT

A heavy duty, configurable shear/crusher demolition tool has an upper jaw, a lower jaw, and a pivot group connecting the upper jaw and the lower jaw; a configurable number of tooth holders mounted on the upper jaw and the lower jaw; a configurable number of teeth removably mounted to the tooth holders; a configurable number of shear blade holders mounted on the upper jaw and the lower jaw; and a configurable number of shear blades removably mounted to the shear blade holders.

### BACKGROUND OF THE INVENTION

This invention relates to a heavy duty demolition apparatus, especially adapted to be mounted on a rigid boom of a mobile vehicle and particularly adapted to be mounted on the dipper stick of an excavator, and particularly to such an apparatus with interchangeable jaws. A fuller understanding of the operation of the demolition apparatus of the present invention may be achieved by studying U.S. Pat. No. 4,519,135, hereby incorporated by reference.

Heavy duty shears of the type that are powered by hydraulic cylinders are proving more and more useful in handling scrap and especially metal scrap of all sorts. Such scrap comes in many different forms, and may be in the form of pipes made of steel or soft iron or cast iron, ranging in sizes from 2 inches or smaller, and up to 8 or 10 inches in diameter or larger; structural beams such as I-beams, channels, angle beams in a large range of sizes, up to 8 or 10 inches across and larger; rods and heavy cables having diameters of 2 to 3 inches and larger, metal sheets and plates and formed metal of all sorts including wheels and automobile and truck frames, and a myriad of long and short pieces of stock and metal pieces that are cast, rolled, stamped or otherwise formed, both singly and in various types of assembly.

The prior art has included numerous shears such as that illustrated in U.S. Pat. No. 4,198,747; U.S. Pat. No. 4,188,721; U.S. Pat. No. 4,897,921; U.S. Pat. No. 4,543,719; U.S. Pat. No. 4,558,515 and U.S. Pat. No. 4,104,792. Typically, these heavy duty shears mount on the dipper stick of an excavator so that the shears may be controlled fairly well in handling various types of scrap and cutting the scrap into smaller twisted and contorted pieces and lengths as the scrap is drawn into the throat of the shear.

Typically, these shears have a fixed lower jaw and a movable upper jaw that pivots on the lower jaw, with shear blades of hardened steel on both the upper jaw and the lower jaw. The workpiece is sheared by closing the upper jaw against the lower jaw under hydraulic pressure, with the shear blades cutting the workpiece.

Shears such as these have various types of jaw attachments that may be used, for example, for cutting steel or other structural material, including concrete, or for crushing concrete, rock, or coral. To meet these needs, in the past it was desirable to be able to remove the jaws from the shear and replace them with jaws of another type. In the past, this has been done by detaching the jaws at the main pivot point. The main pivot pin of the jaws was slid out of the jaws and the adjacent frame plates. It was also necessary to disconnect pivot pins that attached the jaws to their hydraulic cylinders.

One problem with shears such as this is that the main pivot pin cannot be made very heavy and durable, as it must be slid out from the jaws. Also, the main pivot pin was subject to contamination when changing jaws. Furthermore, removing the main pivot pin exposed operating personnel to injury, as either the pin itself or the jaws might cause injury as the pin was removed.

There is a need for a heavy duty configurable shear crusher demolition tool with crushing teeth and shear blades that can be easily mounted on and demounted from the jaws without removing the jaws from the demolition apparatus.

### SUMMARY OF THE INVENTION

A heavy duty, configurable shear/crusher demolition tool has an upper jaw, a lower jaw, and a pivot group connecting the upper jaw and the lower jaw; a configurable number of tooth holders mounted on the upper jaw and the lower jaw; a configurable number of teeth removably mounted to the tooth holders; a configurable number of shear blade holders mounted on the upper jaw and the lower jaw; and a configurable number of shear blades removably mounted to the shear blade holders.

A principal object and advantage of the present invention is jaw components such as tooth holders and shear blade pockets may be mounted to the jaws in order to meet the needs of a specific customer.

Another principal object and advantage of the present invention is that the tooth holders may receive a variable number of removable teeth, which are removable and replaceable in the event of wear.

Another principal object and advantage of the present invention is that the shear blade pockets may receive a variable number of removable shear blades, which are removable and replaceable in the event of wear.

Other advantages will be understood from reading the Detailed Description of Preferred Embodiments.

### BRIEF DESCRIPTION OF THE DRAWINGS

FIG. 1 is a perspective view of the present invention without any tooth holders or shear blade holders attached.

FIG. 2 is a side elevational view of the present invention attached to the boom structure of an excavator.

FIG. 3 is an exploded perspective view of a tooth holder of the present invention and attached removable teeth.

FIG. 4 is a perspective view of a tooth holder of the present invention.

FIG. 5 is an exploded perspective view of a shear blade holder of the present invention with attached removable shear blades.

FIG. 6 is a detailed view of the pivot group of the present invention with surrounding structure cut away.

FIGS. 7A-7C are perspective views showing various embodiments of the present invention.

### DETAILED DESCRIPTION OF THE PREFERRED EMBODIMENTS

The heavy-duty configurable shear crusher demolition tool of the present invention is generally referred to in the Figures as reference numeral 10.

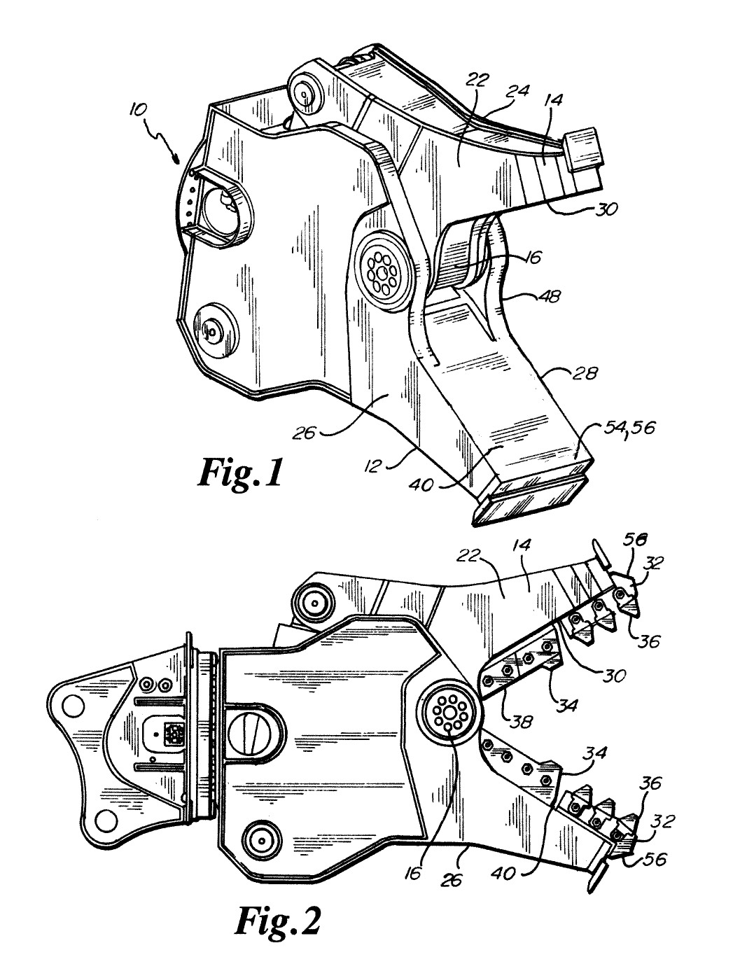

Referring to FIGS. 1 and 2, the heavy-duty demolition apparatus 10 has a lower jaw 12, an upper jaw 14, and pivot pin 16 interconnecting the lower jaw 12 and upper jaw 14.

The upper jaw 14 has a first side 22, and a second side 24. The lower jaw 12 has a first mounting plate 26 adjacent the first side 22, and a second mounting plate 28 adjacent the second side 24. The first mounting plate 26 and second mounting plate 28 receive the pivot pin 16 between them.

The upper jaw 14 further comprises an upper plate 30 for receiving tooth holders 32 and/or shear blade holders 34. Teeth 36 may be removably mounted to the tooth holders 32 as will be further described. The size of the tooth holders 32 and the number of teeth 36 mounted thereon is configurable. Shear blades 38 may be removably mounted to the shear blade holders 34 as will be further described. The size of the shear blade holders 34 and consequently the number of shear blades 38 mounted thereon is configurable. Preferably, the tooth holders and shear blade holders are welded to the upper plate 30 but could be fastened on individually or in groups.

The lower jaw 12 further comprises a lower plate 40 for receiving tooth holders 32 and/or shear blade holders 34. Teeth 36 may be removably mounted to the tooth holders 32 as will be further described. The size of the tooth holders 32 and the number of teeth 36 mounted thereon is configurable. Shear blades 38 may be removably mounted to the shear blade holders 34 as will be further described. The size of the shear blade holders 34 and consequently the number of shear blades 38 mounted thereon is configurable. Preferably, the tooth holders and shear blade holders are welded to the lower plate 40 but could be fastened on individually or in groups.

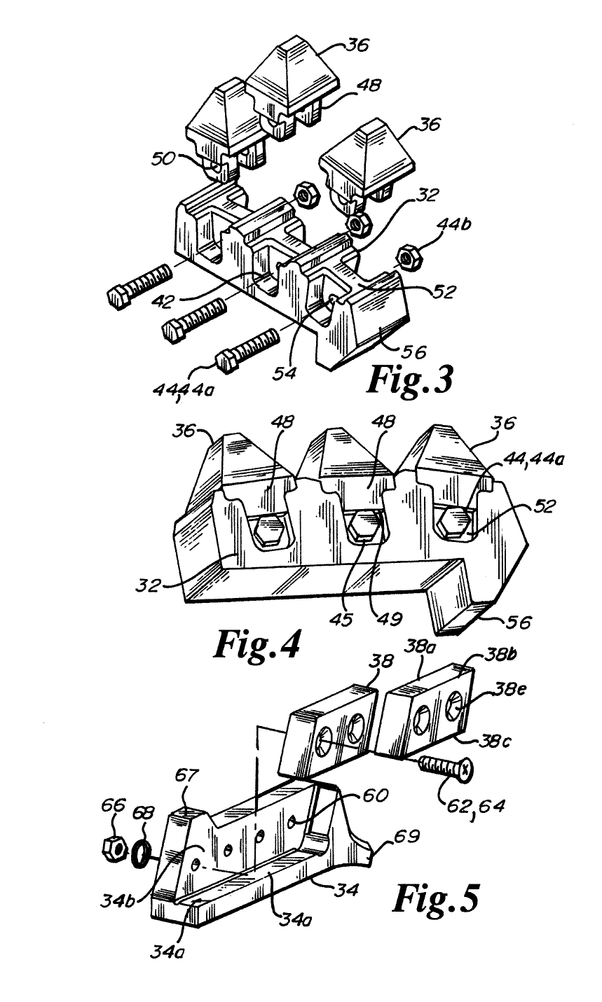

Turning to FIGS. 3 and 4, the structure of the tooth holders 32 and teeth 36 may now be further appreciated. The tooth holders 32 further comprise a configurable number of tooth pockets 42 which receive teeth 36. Teeth 36 are removably mounted in the tooth pockets 42 by fasteners 44 which are preferably bolts 44a and corresponding nuts 44b. Teeth 36 further preferably comprise legs 48 with apertures 50 for receiving the bolt 44a. Tooth pockets 42 further preferably comprise flanges 52 with apertures 54 for receiving the bolt 44a. The legs 48 preferably slidingly engage the flanges 52 for mounting thereon. FIG. 4 illustrates that the flanges 52 are inset within the pockets 42 so that when the bolts 44a are engaged with the flanges, the heads of the bolts are effectively countersunk within the pockets 42. Furthermore, the legs 48 have flat surfaces 49 which engage the heads 45 of the bolts 44, thereby preventing the bolts from rotating.

FIGS. 3 and 4 also illustrate that the tooth holders 32 preferably further comprise extended front portions 56 which engage the lower jaw 12 and upper jaw 14 as shown in FIG. 2 to alleviate wear to the lower jaw 12 and the upper jaw 14.

Turning to FIG. 5, the structure of the shear blade holders 34 and shear blades 38 may be further appreciated. As can be seen, the shear blades 38 are generally rectangular or a parallelogram. The blades have four long edges 38a, 38b, 38c, and 38d (not shown). The blades may be mounted in the shear blade holders 34 so that any of the four long edges may engage a work piece, and the blades may be thus indexed when one of the edges becomes worn. The shear blade holders 34 have two surfaces 34a, 34b which engage surfaces of the blades 38 when the blades 38 are mounted thereon. Apertures 60 through surface 34b receive fasteners 62 such as bolts 64 and nuts 66 with washers 68. Blades 38 have corresponding apertures 38e receiving the fasteners 62.

A stop 67 may be formed in a blade holder 34 to prevent a work piece from sliding out of the jaws.

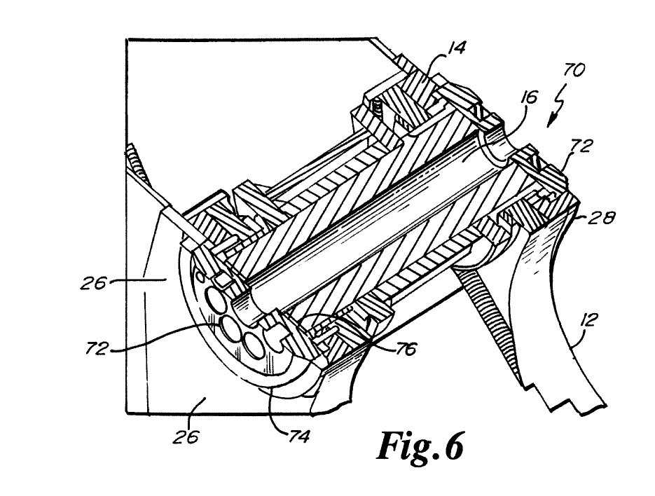

FIG. 6 illustrates the pivot group 70 mounted in the upper jaw 14. The pivot group 70 further comprises the pivot pin 16, which is press-fit into the upper jaw 14 as to rotate with the upper jaw 14. The press-fit pivot pin 16 provides rigidity to the tool 10 by acting as a tie-rod between the first 26 and second 28 mounting plates of the lower jaw 12. The pivot group 70 further comprises a recessed end cap 72 at each end of the pivot pin 16. The recessed end cap 72 has a tapered edge 74 that prevents damage to the pivot group 70. Shims 76 may be placed between the end cap 72 and the pivot pin 16 to adjust the position of the upper jaw 14 relative to the pivot pin 16.

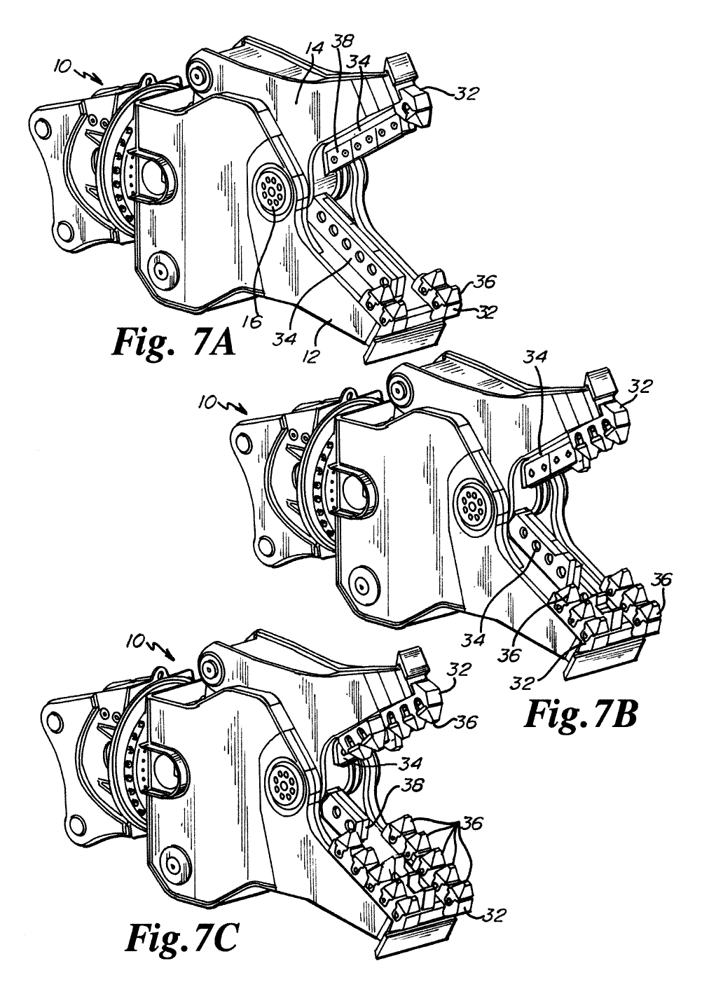

FIGS. 7A-7C illustrate, without limitation, a number of configurations of the configurable shear crusher 10.

The present invention may be embodied in other specific forms without departing from the spirit or essential attributes thereof, and it is therefore desired that the present embodiment be considered in all respects as illustrative and not restrictive reference being made to the appended claims rather than to the foregoing description to indicate the scope of the invention.

What is claimed:

1. A heavy duty, configurable shear/crusher demolition tool, comprising:
(a) an upper jaw, a lower jaw, and a pivot group connecting the upper jaw and the lower jaw;
(b) a plurality of tooth holders mounted either on the upper jaw or the lower jaw;
(c) a plurality of teeth removably mounted to the plurality of tooth holders;
(d) a plurality of shear blade holders mounted either on the upper jaw or the lower jaw; and
(e) a plurality of shear blades removably mounted to the plurality of shear blade holders.

2. The demolition tool of claim 1, wherein the upper jaw further comprises an upper plate, the plurality of tooth holders and plurality of shear blade holders being mounted to the upper plate.

3. The demolition tool of claim 2, wherein the lower jaw further comprises a lower plate, the plurality of tooth holders and plurality of shear blade holders being mounted to the lower plate.

4. The demolition tool of claim 1, wherein the plurality of tooth holders further comprise a configurable number of tooth pockets receiving the teeth and fasteners mounting the teeth in the tooth pockets.

5. The demolition tool of claim 4, wherein the plurality of shear blade holders further comprise mounting surfaces receiving a configurable number of shear blades and fasteners mounting the shear blades to the mounting surfaces.

6. The demolition tool of claim 1, wherein the pivot group further comprises a pivot pin rotating with the upper jaw and a recessed end cap mounted to each end of the pivot pin.

7. The demolition tool of claim 6, wherein the pivot pin is press-fit into the upper jaw.

8. The demolition tool of claim 6, wherein the recessed end cap further comprises a tapered edge preventing damage to the pivot group.

9. The demolition tool of claim 6, further comprising at least one shim mountable in the upper jaw between the pivot pin and an end cap.

10. The demolition tool of claim 4, wherein each of the plurality of tooth pockets further comprises a flange with a flange aperture therethrough and wherein each of the plurality of teeth further comprises a leg with a leg aperture therethrough, the leg engaging the flange and the fastener engaging the flange aperture and the leg aperture to removably mount the tooth to the tooth pocket.

11. The demolition tool of claim 10, wherein the fastener is a bolt having a head with a flat surface and wherein the leg further comprises a flat surface engaging the flat surface of the head thereby preventing rotation of the bolt.

12. The demolition tool of claim 1, wherein the tooth holder further comprises a protective, extended portion engaging the front of one of the upper jaw and the lower jaw.

13. The demolition tool of claim 5, wherein each of the shear blade holders further comprises a blade holder aperture therethrough and wherein each of the shear blades further comprises a blade aperture therethrough, wherein the fastener engages the blade holder aperture and the blade aperture to removably mount the shear blade to the shear blade holder.

14. The demolition tool of claim 13, wherein each of the shear blades is rectangular, having four shearing edges, and wherein each of the shear blades is mountable on a shear blade holder to expose any of the four shearing edges to shear a work piece.

15. The demolition tool of claim 1, further comprising a stop formed in a shear blade holder to prevent a work piece from sliding out of the jaws.

16. A heavy duty, configurable shear/crusher demolition tool, comprising:
(a) an upper jaw, a lower jaw, and a pivot group connecting the upper jaw and the lower jaw;
(b) a plurality of tooth holders mounted on the upper jaw and the lower jaw;
(c) a plurality of teeth removably mounted to the plurality of tooth holders wherein the plurality of tooth holders further comprise a configurable number of tooth pockets receiving the teeth and fasteners mounting the teeth in the tooth pockets;
(d) a plurality of shear blade holders mounted on the upper jaw and the lower jaw; and a plurality of shear blades removably mounted to the plurality of shear blade holders wherein the plurality of shear blade holders further comprise mounting surfaces receiving a configurable number of shear blades and fasteners mounting the shear blades to the mounting surfaces.

17. A heavy duty, configurable shear/crusher demolition tool, comprising:
(a) an upper jaw, a lower jaw, and a pivot pin connecting the upper jaw and the lower jaw;
(b) a plurality of tooth holders mounted on the upper jaw and the lower jaw;
(c) a plurality of teeth removably mounted to the plurality of tooth holders wherein the plurality of tooth holders further comprise a configurable number of tooth pockets receiving the teeth and fasteners mounting the teeth in the tooth pockets;
(d) a plurality of shear blade holders mounted on the upper jaw and the lower jaw; and a plurality of shear blades removably mounted to the plurality of shear blade holders wherein the plurality of shear blade holders further comprise mounting surfaces receiving a configurable number of shear blades and fasteners mounting the shear blades to the mounting surfaces;
(e) a stop formed in a shear blade holder to prevent a work piece from sliding out of the jaws; and
(f) wherein the tooth holder further comprises a protective, extended portion engaging the front of one of the upper jaw and the lower jaw.

18. The demolition tool of claim 17, wherein each of the plurality of tooth pockets further comprises a flange with a flange aperture therethrough and wherein each of the plurality of teeth further comprises a leg with a leg aperture therethrough, the leg engaging the flange and the fastener engaging the flange aperture and the leg aperture to removably mount the tooth to the tooth pocket.
